(19) United States
(12) Patent Application Publication
(10) Pub. No.: US 2014/0214564 A1
(43) Pub. Date: Jul. 31, 2014

(54) METHOD TO ALLOW TWO OR MORE MOBILE DEVICES TO CONTRIBUTE ITEMS TO THE SAME VIRTUAL SHOPPING CART IN MOBILE SELF CHECKOUT SOFTWARE

(71) Applicant: WAL-MART STORES, INC., Bentonville, AR (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 13/756,358

(22) Filed: Jan. 31, 2013

(51) Int. Cl. G06Q 30/06

(52) U.S. Cl. CPC G06Q 30/0633
USPC 705/16; 705/26.8

(57) ABSTRACT

Techniques for allowing multiple mobile electronic devices to contribute items to a single electronic shopping cart are disclosed. The techniques include electronically pairing a first mobile electronic device with a second mobile electronic device. The techniques also include receiving a UPC code from a first physical item at a brick and mortar store into self-checkout software on the first mobile electronic device, receiving first item information for the first item into the self-checkout software on the first mobile electronic device, creating an electronic shopping cart with the first item information on the first mobile electronic device, and transmitting information regarding the first item to the second mobile electronic device to thereby create a synced copy of the electronic shopping cart on the second mobile electronic device.

### BACKGROUND INFORMATION

1. Field of the Disclosure

The present invention relates to shopping at a retail location. In particular, examples of the present invention relate to an approach for allowing two or more customers with electronic devices at a brick and mortar store to transfer items to a common virtual shopping cart for purchase.

2. Background

Many consumers visit supermarkets and stores with other people while shopping. It is not uncommon for a group of friends or a family to go shopping together. These persons may move throughout a store to find the desired items. In some cases, these people may attempt to split up a shopping list and work individually to find the desired items more quickly. This may result in persons making multiple trips to various parts of the store, as a person may have collected an item that another person already collected, an item that is the wrong brand or kind, etc. In some cases, other people in the group may have simply changed their mind about an item. The difficulties and inefficiencies with splitting a shopping list among multiple people may result in this approach to shopping taking as much time as simply remaining as a group and collecting a single item at a time.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a schematic illustrating a mobile electronic device used in accordance with some aspects of the present disclosure;

FIG. 2 is a schematic illustrating a mobile electronic device and a POS system used in accordance with some aspects of the present disclosure;

FIG. 3 is a schematic illustrating a POS system used in accordance with some aspects of the present disclosure;

FIG. 4 is a schematic illustrating a POS system used in accordance with some aspects of the present disclosure;

FIG. 5 is a schematic illustrating communications between a mobile electronic device and a server;

FIG. 6 is a drawing of a mobile electronic device with software thereon according to aspects of the present disclosure;

FIG. 7 is a drawing of a mobile electronic device with software thereon according to aspects of the present disclosure;

FIG. 8 is a drawing of a mobile electronic device with software thereon according to aspects of the present disclosure;

FIG. 9 is a drawing of a mobile electronic device with software thereon according to aspects of the present disclosure;

FIG. 10 is a schematic illustrating communications between a mobile electronic device and a POS system;

FIG. 11 is a schematic illustrating example components of a mobile electronic device;

FIG. 12 is a schematic illustrating example components of a server; and

FIG. 13 is a flow chart illustrating an exemplary customer shopping according to aspects of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The disclosure particularly describes how two or more associated customers with mobile electronic devices may shop together at a brick and mortar store. The customer may pair their mobile devices together and then shop in a collaborative manner, individually collecting items for purchase while contributing these items to a common electronic shopping cart. The shopping cart may be displayed on the mobile electronic device of each customer and each customer may provide interaction with other customers via the devices.

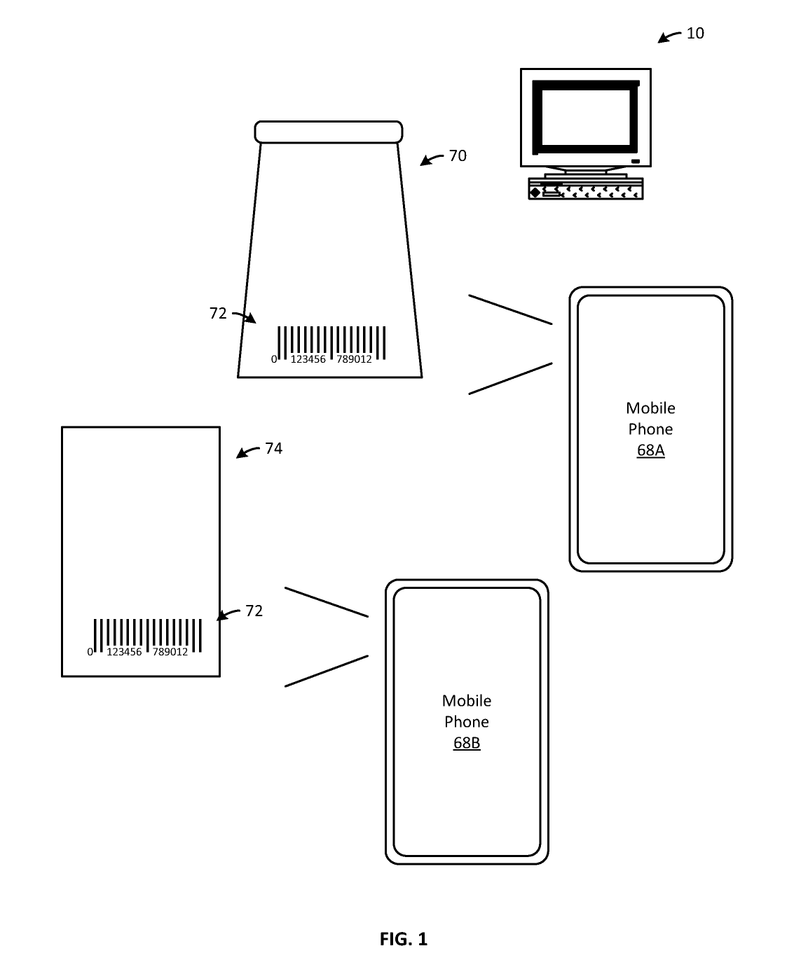

Referring to FIG. 1, a group of customers may shop together in a brick and mortar store. The brick and mortar store may include a point of sale (POS) system 10 including a cash registers or terminals, etc. The store may also stock various physical items for purchase. The customers may utilize mobile electronic devices 68A, 68B, such as smart phones or tablet computers, while shopping. The mobile electronic devices 68A, 68B may be used to scan items as items are selected for purchase, creating an electronic shopping cart. In particular, the customers may work together to create a single common electronic shopping cart which is shared between the mobile electronic devices 68A, 68B.

The customers may have mobile electronic devices 68A, 68B which have mobile self-checkout software loaded thereon. Each customer may use a mobile electronic device 68 while shopping to create an electronic list or electronic shopping cart of items which the customer selects for purchase at the store. By way of example, the customer may select an item 70 for purchase and may use the mobile electronic device 68A to capture a UPC code 72 on that item. The mobile self-checkout software on the mobile electronic device may, from the UPC code 72, obtain and store information regarding the product 70. The customer may proceed in this manner while shopping, selecting items for purchase, scanning the UPC code associated with that item, and creating an electronic shopping cart on the mobile electronic device 68 which includes a list of items selected for purchase.

Additionally, a second customer who is associated with the first customer may also select an item 74 for purchase and may use their mobile electronic device 68B to capture a UPC code 72 on that item. The mobile self-checkout software on the mobile electronic device may, from the UPC code 72, obtain and store information regarding the product 70. The second customer may proceed in this manner while shopping, selecting items for purchase, scanning the UPC code associated with that item, and adding these items to the electronic shopping cart.

The first customer and second customer are typically friends, members of the same family, etc. and may have come together to the store for shopping. As the first customer and second customer are shopping together at the store, they typically have common interest in the products selected for purchase by each other and may have created a shopping list together or otherwise discussed which items needed to be purchased at the store. A single shared electronic shopping cart may be created by the first customer and the second customer and this cart may be displayed on each of their electronic devices 68A, 68B. Additional customers may also contribute items to the shared shopping cart as discussed.

As one of these customers adds an item to the electronic shopping cart the electronic shopping cart may provide information to assist these customers. The electronic shopping cart may include information regarding which of the customers selected the item and may provide such information to each of the customers to assist them in managing the electronic shopping cart and to assist them in being aware of what the other customer has selected and added to the shopping cart. The customers may also be allowed to send comments, notifications, or requests to each other via the mobile self-checkout software. These communications may allow the customers to easily communicate about the selected items or other aspects of the shopping trip.

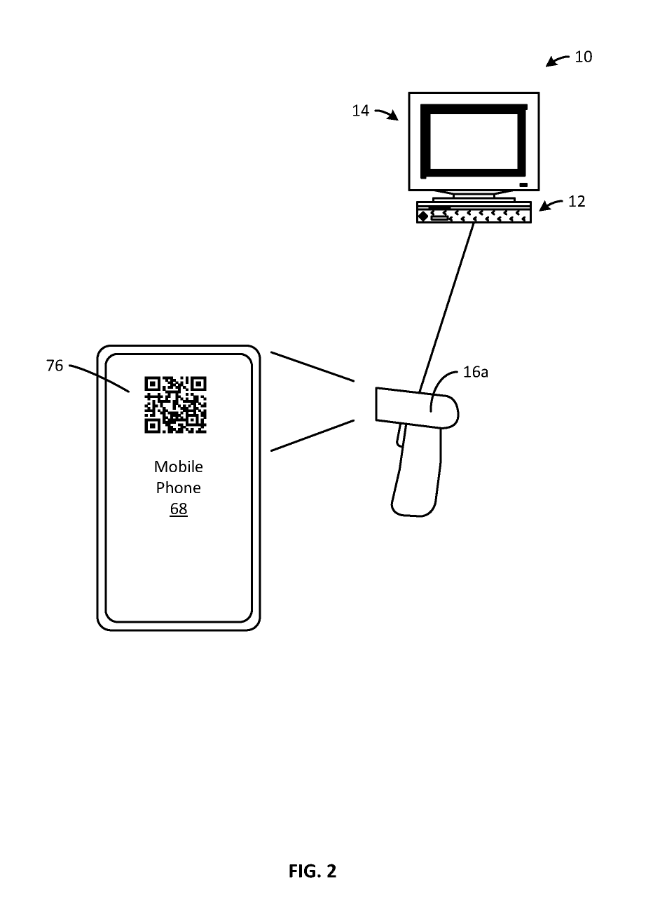

As illustrated in FIG. 2, when the customers are ready to checkout and pay for the selected items, the customers may finalize the shopping cart. One or both of the customers will typically approach a POS terminal 10 to complete the purchase. The POS terminal 10 may be a self-checkout register or a conventional sales register with a cashier. The customer will typically have a physical shopping cart or basket with the selected items and will have an electronic shopping cart containing information about those items on a mobile electronic device 68. The customer may indicate on the mobile electronic device that they are ready to checkout. To facilitate checkout, the customer may pair their mobile electronic device 68 with the POS terminal. In some situations, pairing the mobile electronic device 68 with the POS terminal and indicating on the device to checkout may transfer the electronic shopping cart information to the POS terminal. The customer may pair with the POS terminal by scanning a machine readable code such as a 2D barcode at the POS terminal. The server 34 may transmit electronic shopping cart information to the POS terminal.

In some situations, the mobile electronic device 68 may prepare information for the POS terminal 10 to convey the list of items in the electronic shopping cart to the POS terminal for purchase. The mobile electronic device 68 may prepare one or more machine readable codes 76, such as a 2D barcode or QR code, which have information regarding the selected items in order to convey this information to the POS terminal.

2D machine readable codes can convey significant amounts of information. The machine readable code 76 may be prepared with product information such as the numeric UPC code of the products in the shopping cart embedded in the machine readable code as a payload. If there are too many products to fit within a single machine readable code 76, a series of machine readable codes can be prepared and flashed in sequence as they are acquired by the POS terminal. An optical scanner 16a associated with the POS terminal 10 may be used (either by the customer at a self-checkout lane or by a cashier at an assisted checkout lane) to capture the machine readable code 76 and thereby receive information regarding the selected items for purchase.

The list of items in the electronic shopping cart is thus transferred to the POS terminal 10 without requiring all items to be scanned individually at the POS terminal. The customers may then proceed with the checkout and payment process. The customer may thus checkout in an easier manner. The customer may save time while shopping as the item selection and the checkout processes proceed more quickly. The store may save money as fewer cashiers are necessary to handle the number of customers.

Various parts of a POS system and self-checkout system may allow multiple associated customers to scan items into a single digital shopping cart while shopping and to transfer those items from a mobile electronic device to a POS terminal. Various parts and structures are described to illustrate how these may allow a customer to complete a checkout process. Multiple customers may shop and contribute items to a single electronic shopping cart and proceed through the checkout process in an expeditious and convenient manner.

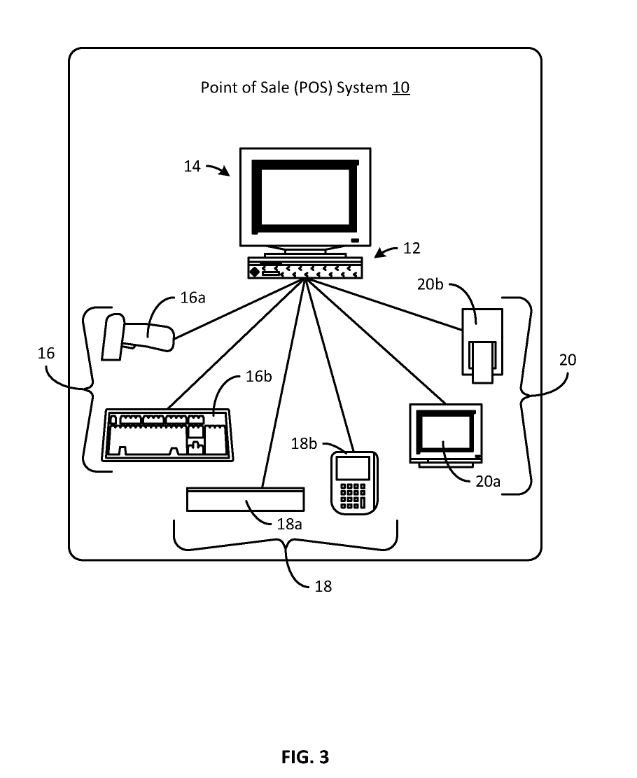

Referring to FIG. 3, in selected embodiments, the hardware, software, or hardware and software of a POS system 10 may be configured to implement one or more embodiments described herein. For example, a POS system 10 may be manufactured, programmed, modified, or upgraded to support communications with mobile electronic devices 68 and to thereby facilitate self-checkout whereby one or more customers create electronic shopping carts while selecting items in the store. It is appreciated that the POS system may involve one or more parts of a local POS terminal and associated computers or servers, remote computers or servers, customer devices such as a mobile electronic device, and associated equipment.

A POS system 10 may include various components. In certain embodiments, a POS system 10 may include a central or primary computer 12, a monitor 14 (e.g., a cashier-facing monitor 14), one or more input devices 16 (e.g., scanners 16a, keyboards 16b, scales, or the like), one or more payment devices 18 (e.g., cash drawers 18a, card readers 18b) for receiving or returning payments, one or more output devices 20 (e.g., customer-facing display 20a or monitor 20a, receipt printer 20b), or the like or combinations or sub-combinations thereof.

A computer 12 may form the primary processing unit of a POS system 10. Other components 16, 18, 20 forming part of a POS system 10 may communicate with the computer 12. Input devices 16 and certain payment devices 18 may feed data and commands to a computer 12 for processing or implementation. For example, a scanner 16a may pass data communicating the identity of one or more items to be purchased, returned, or the like to a computer 12. Similarly, a card reader 18b may pass payment information to a computer 12.

Conversely, output devices 20 and certain payment devices 18 may follow or implement commands issued by a computer 12. For example, a cash drawer 18a may open in accordance with the commands of a computer 12. Similarly, a customer-facing display 20a and receipt printer 20b may display or output data or information as instructed by a computer 12.

In selected embodiments, in addition to handling consumer transactions (e.g., purchases, returns), a POS system 10 may also provide or support certain “back office” functionality. For example, a POS system 10 may provide or support communications with mobile electronic devices 68, inventory control, purchasing, receiving and transferring products, or the like. A POS system 10 may also store sales and customer information for reporting purposes, marketing purposes, receivables management, trend analysis, cost analysis, price analysis, profit analysis, or the like. If desired or necessary, a POS system 10 may include an accounting interface to pass certain information to one or more in-house or independent accounting applications. A POS system 10 may also communicate with third parties and may transmit receipt information and facilitate customer management of receipts.

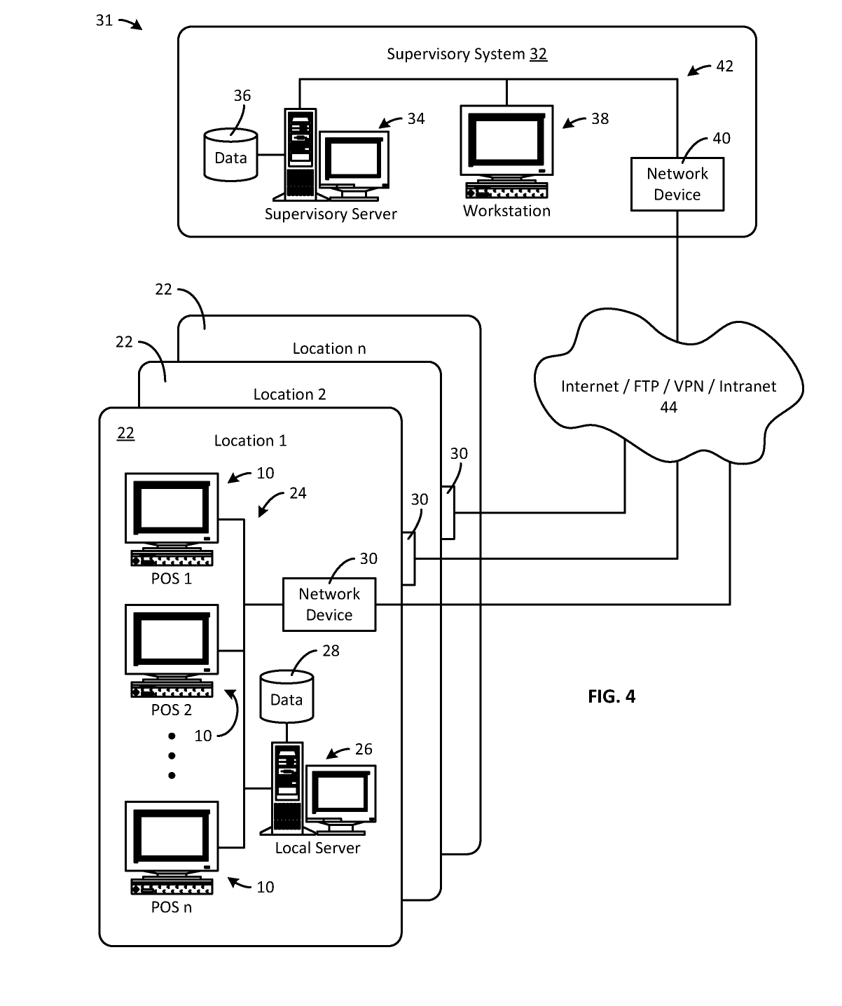

Referring to FIG. 4, in selected embodiments, a POS system 10 may operate substantially independently, as a stand-alone unit. Alternately, a POS system 10 may be one of several POS systems 10 forming the front line of a larger system. For example, multiple POS systems 10 may operate at a particular location 22 (e.g., within a retail, brick-and-mortar store). In such embodiments, the various POS systems 10 may be interconnected via a LAN 24. A LAN 24 may also connect the POS systems 10 to a local server 26.

A local server 26 may support the operation of the associated POS systems 10. For example, a server 26 may provide a central repository from which certain data needed by the associated POS systems 10 may be stored, indexed, accessed, or the like. A server 26 may serve certain software to one or more POS systems 10. In certain embodiments, a POS system 10 may offload certain tasks, computations, verifications, or the like to a server 26.

Alternatively, or in addition thereto, a server 26 may support certain back office functionality. For example, a server 26 may receive and compile (e.g., within one or more associated databases 28) data from the various associated POS systems 10 to provide or support inventory control, purchasing, receiving and transferring products, or the like. A server 26 may also receive and compile sales and customer information for reporting purposes, marketing purposes, receivables management, trend analysis, cost analysis, price analysis, profit analysis, or the like.

In certain embodiments, one or more POS systems 10 or servers 26 corresponding to a particular location 22 may communicate with or access one or more remote computers or resources via one or more network devices 30. For example, a network device 30 may enable a POS system 10 to contact outside resources and verify the payment credentials (e.g., credit card information) provided by a customer. A network device 30 may comprise a modem, router, or the like.

In selected embodiments, a POS system 10 may operate within an enterprise-wide system 31 comprising multiple locations 22 (e.g., branches 22 or stores 22). In such embodiments, each location 22 may have one or more POS systems 10, local servers 26, local databases 28, network devices 30, or the like or combinations or sub-combinations thereof connected by a computer network (e.g., a LAN 24). Additionally, each such location 22 may be configured to interact with one or more supervisory systems 32. For example, multiple branch locations 22 may report to an associated “headquarters” location or system 32.

A supervisory system 32 may comprise one or more supervisory servers 34, databases 36, workstations 38, network devices 40, or the like or combinations or sub-combinations thereof. The various components of a supervisory system 32 may be interconnected via a computer network (e.g., a LAN 42). In selected embodiments, a supervisory system 32 may comprise one or more supervisory servers 34 providing a central repository from which certain data needed by the one or more POS systems 10 or local servers 26 may be stored, indexed, accessed, or the like.

Alternatively, or in addition thereto, a supervisory server 34 may receive and compile (e.g., within one or more associated databases 36) data from the various associated POS systems 10 or local servers 26 to provide or support inventory control, purchasing, receiving and transferring products, or the like. A supervisory server 34 may also receive and compile sales and customer information for reporting purposes, marketing purposes, receivables management, trend analysis, cost analysis, price analysis, profit analysis, or the like.

A supervisory system 32 may be connected to one or more associated locations 22 or branches 22 in via any suitable computer network 44 (e.g., WAN 44). For example, in selected embodiments, one or more locations 22 may connect to a supervisor system 32 via the Internet. Communication over such a network 44 may follow any suitable protocol or security scheme. For example, communication may utilize the File Transfer Protocol (FTP), a virtual private network (VPN), intranet, or the like.

It is thus appreciated that in discussing the functionality of the various POS terminals and servers, the embodiments described herein may be implemented in a system contained within a single location or across multiple locations. By way of example, the functionality accomplished by a server or computer, such as storing, processing, and transmitting/sending receipt information, may be accomplished by a local computer or a remote computer such as servers 26 and 34.

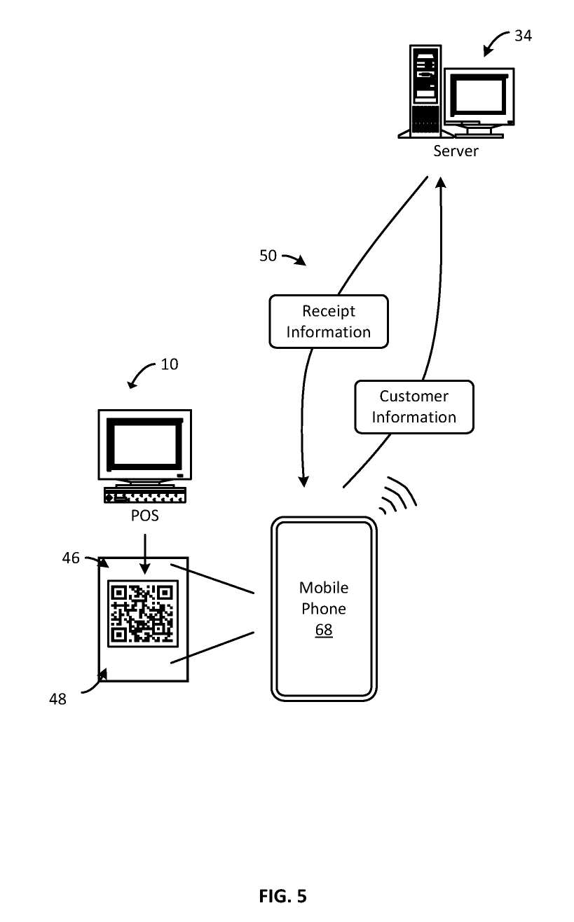

Referring to FIG. 5, customers may use a mobile electronic device 68 while shopping. The mobile electronic device may be a mobile phone such as a smart phone, a tablet computer, etc. In many instances, the mobile electronic device 68 is a mobile phone. The customer may download or may already have downloaded self-checkout software to a mobile electronic device 68. A customer may have previously received a paper receipt 46 or other medium which includes an invitation such as a machine readable code 48 to download and use self-checkout software and may have installed self-checkout software on the mobile electronic device 68. A customer may have alternatively received an invitation from a friend or other person to download and use self-checkout software.

As indicated at 50, the customer may have created an account with a receipts/shopping server 34 (or server 26) and may transmit information to the server 34. The computer server 34 may likewise transmit information to the mobile device 68. The customer may receive self-checkout software on the mobile device 68 which may enable them to manage their in-store shopping experience with their mobile electronic device. Additionally, the self-checkout software may allow the customer to interact with a POS system 10 via the mobile electronic device 68. The server 34, server 26, or other devices may facilitate communication with the mobile electronic device 68. Multiple customers may download self-checkout software as discussed above. If desired, these customers may create accounts with the server 34.

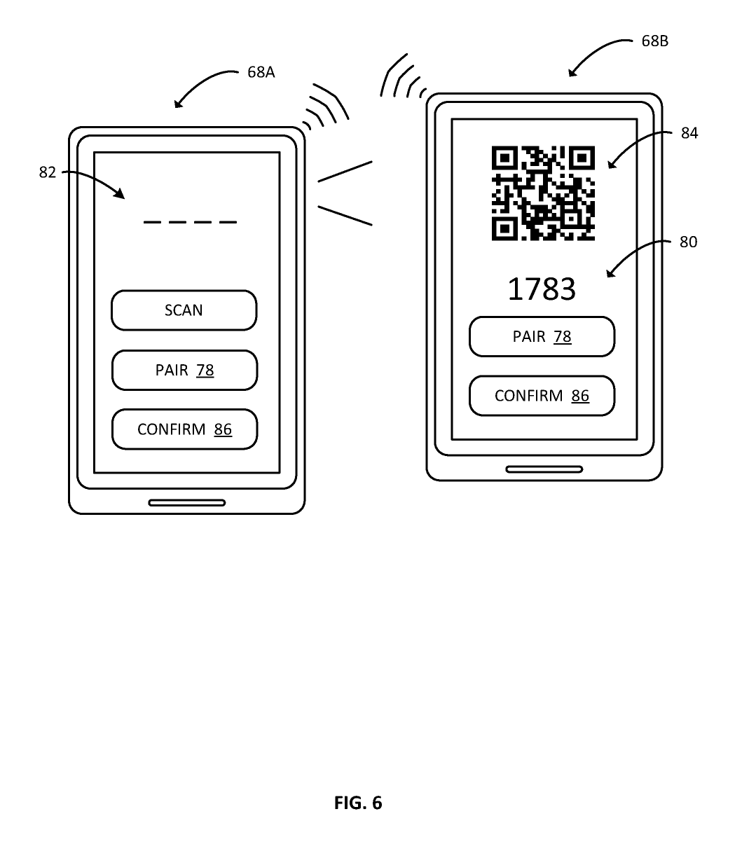

Referring to FIG. 6, two or more customers who are shopping together may first pair their mobile electronic devices 68A, 68B. These customers would typically enter self-checkout software on their mobile electronic devices 68A, 68B and may then enter a shared shopping function in the software. Each of the customers may press a loin carts' or pair button 78 to pair the mobile electronic devices 68A, 68B together. The customer may enter an identification number such as a device telephone number for the other mobile electronic device before pairing to facilitate communications between the devices. In pairing the mobile electronic devices, it is typically desirable to identify the devices so that each device knows the identification of the other device(s) so that information can be transmitted between the devices.

The devices may be paired together in multiple different ways. One of the mobile electronic devices 68B may produce a unique sound and the other mobile electronic device 68A may capture that sound to identify the two devices. One device 68B may create a pin number 80 and a customer may enter the pin 80 into an appropriate data field 82 on the device 68A. One mobile electronic device 68B may create a machine readable code 84 such as a QR code and the other device(s) 68A may capture the code 84 with a camera. The devices 68A, 68B may be bumped together and may record the vibrations from the bump. A text message with a code may be sent from one mobile electronic device 68A to the other mobile electronic device 68A. Multiple different ways may be utilized to pair these mobile electronic devices together.

During the pairing process, one device 68B may provide the created code 80, 84, etc. to a server 34 which facilitates self-checkout and communications between devices. The other device 68A may provide the received code to the server 34 and the server may identify the codes which it receives and match the devices 68A, 68B together. The server may provide information to the devices 68A, 68B, such as providing a telephone number or device identification number for the devices to facilitate communication between the devices.

In these methods of pairing the devices together, each device 68A, 68B is party to a particular code or piece of information which identifies the devices with a particular transaction; that of joining together for shopping at the store. Pairing the devices 68A, 68B together may provide each device with a device identification such as a telephone number for the other paired device(s) and may thus facilitate communication between the devices.

In addition to the above, the self-checkout software may utilize additional information to identify the mobile electronic devices and pair them together. If desired, the self-checkout software may use geofencing or device proximity to assist in identifying the devices which are being paired together. The server 34 or self-checkout software may use geofencing to confirm that the devices which are being paired together are all in geographic proximity to each other, such as being in proximity to a store. The server 34 or self-checkout software may also use device proximity, such as verifying that the devices being paired are on the same WIFI network. The use of geofencing or device proximity may assist the server 34 or software to identify the devices which are intended to be paired together. After entering, capturing, or transmitting information used for pairing the devices together, the customers may press a confirm button 86 to finalize the device pairing.

For the present discussion, two mobile electronic devices 68A, 68B are discussed. It is appreciated that more than two devices 68 may be paired together as more than two customers shop together and create a common electronic shopping cart. Once paired, the devices 68A, 68B may communicate with each other while the customers are shopping at the store. The devices may communicate through a device network such as a cellular network or WIFI accessed internet. The server 34 may facilitate communication between the devices 68A, 68B. The store may provide WIFI access to the devices 68A, 68B to facilitate communication.

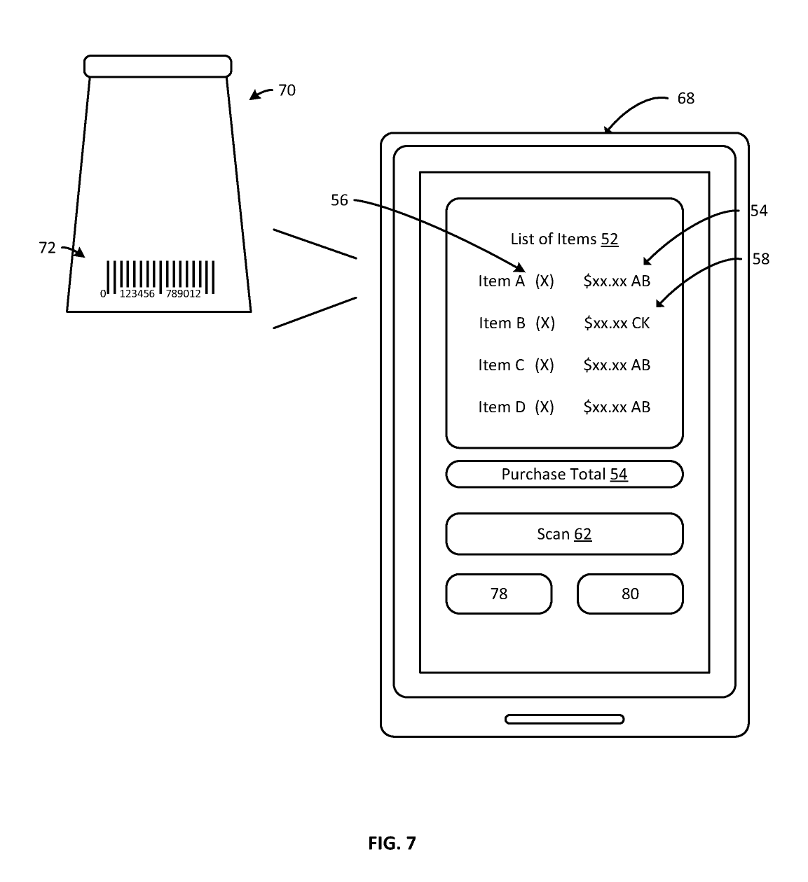

Referring now to FIG. 7, after pairing, a customer may use the mobile electronic device 68 while shopping in the brick and mortar store. In particular, the customer may use the mobile electronic device 68 to scan barcodes such as UPC codes 72 on products 70. A camera on the mobile electronic device 68 may be used to capture the UPC code 72. Mobile self-checkout software loaded onto the mobile electronic device 68 may provide this functionality to the customer, allowing the customer to use the mobile electronic device 68 to capture UPC codes 72 on products 70 as the customer selects these items for purchase in the store. The customer will typically advance through a store selecting physical items 70 for purchase. The customer may select an item 70, capture a UPC code 72 from the item, and place the item in a physical shopping cart or basket for purchase.

Upon capturing a UPC code 72, the self-checkout software may allow the mobile electronic device 68 to receive information about the product. The self-checkout software may obtain information about the product 70 and create an electronic shopping cart with the item information. The mobile self-checkout software may provide a user interface on the device 68 as shown. The self-checkout software, through the mobile electronic device 68, may display a list 52 of selected items/products (such as item 70) to the customer as the customer selects these for purchase.

If desired, the self-checkout software may display the cost 54 of an item next to the item on the list 52. This may require additional information from the customer or store, as this information may not be conveyed with the UPC code. The software may allow the customer to enter in the price of the item while selecting this item, as well as the quantity 56 of the item which the customer is purchasing. If this information is acquired, the mobile self-checkout software may display this information in the list of items 52 in presenting the electronic shopping cart to the customer. The self-checkout software may also display information 58 conveying who scanned a particular item and added that item to the electronic shopping cart. By way of example, the self-checkout software may display a person's mobile phone number, email, avatar, initials or name along with an item in the electronic shopping cart list 52 to indicate that a particular person selected that item and scanned that item to place the item in the electronic shopping cart. This may allow a customer to more easily track and manage the electronic shopping cart. According to another example, an electronic shopping cart list 52 of items may be divided into separate columns or horizontal sections for each customer, indicating which customer added the various items to the electronic shopping cart.

In some cases, a customer may have added items to an electronic shopping cart prior to pairing their mobile electronic device 68 with that of another customer for shared shopping. In this situation, the items already added to an electronic shopping cart may be retained in the shared electronic shopping cart and information regarding these items may be transmitted to the other electronic devices which have been paired together.

The self-checkout software may allow a customer to modify the electronic shopping cart by selecting an item on the list 52 of items. In this manner, a customer may select an item on the list 52, such as by pressing the list item entry on a touch sensitive screen, and then enter a menu command such as a command to remove the item from the electronic shopping cart. If desired, the self-checkout software may require that a customer who added an item to the electronic shopping cart remove that item from the electronic shopping cart.

In some situations, it may be desirable to more precisely manage items added by the different paired customers to the electronic shopping cart. A unique product ID may be created in the electronic shopping cart for each item added, allowing every item to be allocated to or associated with the particular customer who added the item to the electronic shopping cart. In this manner, if a customer removes an item which they added to the electronic shopping cart the self-checkout software may remove a corresponding item associated with that particular customer from the item list 52. Where multiple customers may have selected the same item for purchase, removal of that item by a customer removes an item associated with that customer from the electronic shopping cart.

The self-checkout software may also provide the customer with additional purchase information such as the total purchase cost 60, which may include a tax amount, as the customer selects products for purchase. This may assist the customer in understanding how much they are spending and in otherwise completing their purchase. If desired, the electronic shopping cart may also transmit additional item information such as item name, brand, description, and/or picture may be included in the electronic shopping cart and may be transmitted between the customers to assist in the shopping process.

The self-checkout software may facilitate communication between multiple customers who are contributing items to the electronic shopping cart. As discussed, multiple customers can pair their mobile electronic devices 68A, 68B together and items which are selected for purchase and scanned by the customers are added to a common electronic shopping cart. While shopping, the mobile electronic devices 68A, 68B may communicate with each other such that modifications to the electronic shopping cart made by one customer are shared with the other customer. Each customer may have an updated electronic shopping cart which includes the items selected by other paired customers.

The mobile electronic devices 68A, 68B may communicate with each other via the device's own communications network. The devices 68A, 68B may often be cellular phones and may use the cellular network to communicate. Information for the electronic shopping cart such as item information may be transmitted between the mobile electronic devices 68A, 68B and the devices may thus maintain an updated electronic shopping cart with items selected by each customer.

According to one example, a computer associated with the store such as server 34 may facilitate communication between the mobile electronic devices 68A, 68B. The server may store or transmit information between the mobile electronic devices 68A, 68B. The devices may periodically poll the server to obtain any updates to the electronic shopping cart such as additional items. The server 34, upon receiving a polling request, may transmit shopping cart information to the mobile electronic device 68 to update the electronic shopping cart on the device. The server 34 may ensure that the electronic shopping cart is displayed correctly on each mobile electronic device 68A, 68B without discrepancy, and may periodically transmit a complete copy of the electronic shopping cart to a mobile electronic device to ensure accuracy.

The self-checkout software may provide additional functionality to the customer, such as through virtual buttons 62, 64, 66 or other menu commands. By way of example, a virtual button 62 may be provided to allow a customer to capture a UPC code from an item. Such a virtual button may cause the self-checkout software to operate a camera which is part of the mobile electronic device to capture the UPC code. Virtual button 64 may be used to send a message to another customer, such as a message regarding items in the electronic shopping cart or other items or tasks related to the shopping trip. A virtual button 66 may be used to finalize the shopping trip and enter a checkout mode.

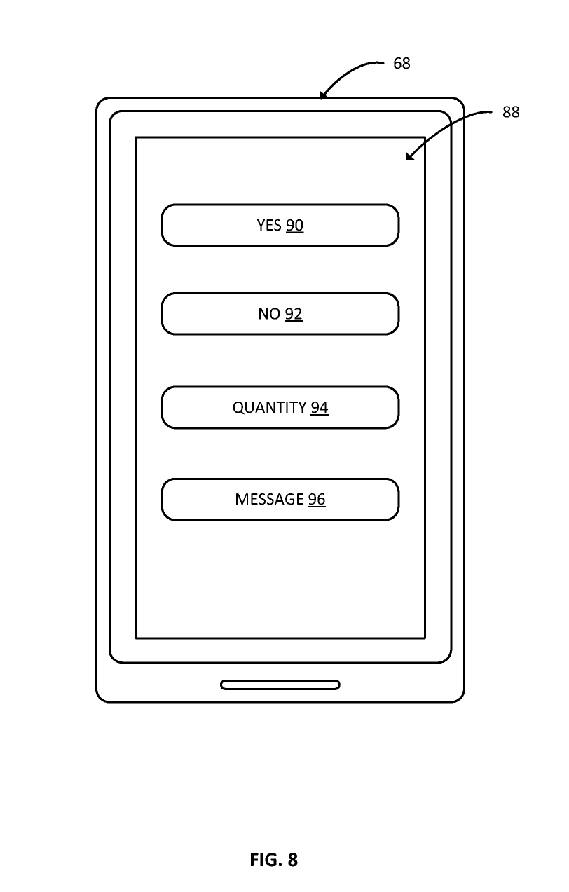

Referring to FIG. 8, the self-checkout software may provide additional notification and communication screens to assist the customers while shopping. The self-checkout software may display a notification screen 88 when another paired customer selects an item and scans a UPC code on the item to add the item to the electronic shopping cart. The notification screen 88 may include virtual buttons for commonly used responses. The notification screen may thus include a virtual button 90 which indicates YES to select that item for purchase and pressing this button may transmit such a message to the customer who scanned that item. Another virtual button 92 may indicate that NO, the item is not to be purchased, and may further include or provide options to indicate that the customer who selected the item should not purchase such an item or should get another brand or type of the item.

A virtual button 94 (i.e. a button or area of a touchscreen user interface which is created by the self-checkout software which, when touched by a user, performs a designated function) may be included which allows a customer to quickly enter a suggested quantity for the scanned item and transmit such a message to the customer who scanned the item. A virtual button 96 may allow a customer to quickly enter a message, such as with a virtual keyboard, and send that message to the customer who scanned that item. In this manner, the self-checkout software may allow a customer to quickly and easily send messages to other customers who are paired together and creating a common electronic shopping cart. Sending such messages within the self-checkout software may be more convenient than exiting the software and using telephone or text messaging software on the mobile electronic device to send the messages.

When a customer has finished selecting items for purchase in the store and desires to checkout, they will typically press a checkout button 66 to indicate this on the mobile electronic device 68. Pressing a checkout button 66 may cause the self-checkout software to send a notification to other customers who are paired together with this customer that a checkout mode has been entered or that a customer in the group desires to checkout. The other paired customer may be provided with an option, such as another virtual button, to indicate that they desire to continue shopping or that they are finished shopping.

If desired, the self-checkout software may allow a customer to easily return to a shopping mode from the checkout mode. The software may allow a customer to press a button or enter a menu command to return to a shopping mode and add additional items to the electronic shopping cart. The self-checkout software may also allow a customer to capture an additional UPC code for an item and thereby return to a shopping mode.

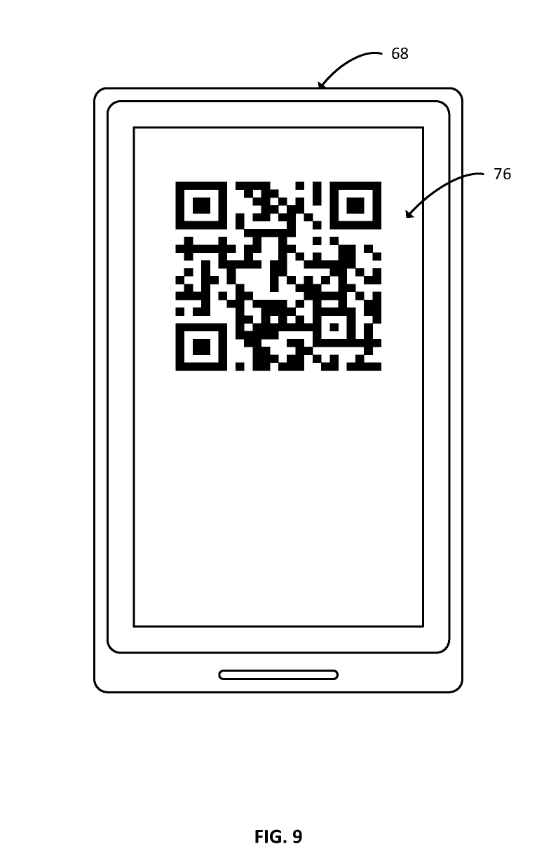

Pressing a checkout button 66 may cause the mobile self-checkout software to enter a checkout mode. The software may prepare the list 52 of selected items for checkout. The software may process information regarding the selected products 70, 74, etc. for transmittal to a POS terminal 10. Typically, the mobile self-checkout software may provide identifying information such as the numeric UPC code 72 and product purchase quantity to the POS terminal 10. Referring to FIG. 9, the software may take the data from the item list 52 such as the UPC code 72 (e.g. the numeric equivalent) and item quantity and embed this information within a machine readable code 76 as a payload. The mobile self-checkout software may shorten or append the UPC codes, such as by appending these codes into the last five numbers of the code, allowing for greater information capacity in the machine readable code 76.

The machine-readable code 76 may comprise a two-dimensional barcode. Two-dimensional barcodes may support or provide more data per unit area than can be obtained using a traditional one-dimensional barcode. A two-dimensional barcode may follow any suitable protocol, format, or system. In selected embodiments, a two-dimensional code may be embodied as a Quick Response (QR) Code or a High Capacity Color Barcode. A single such code 76 may convey UPC and quantity information for many products to the POS terminal.

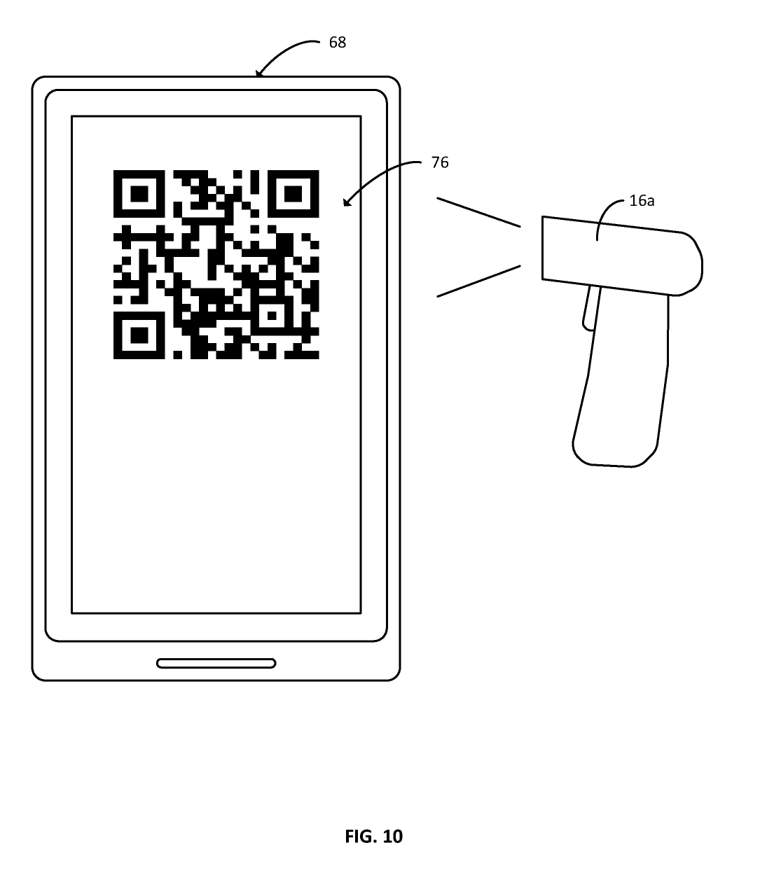

As indicated in FIG. 10, an optical scanner 16a at a POS terminal 10 (not shown for clarity) may be used to capture the machine readable code 76 produced on the mobile electronic device 68 and thus acquire UPC and/or product quantity information for the POS terminal. It will be appreciated that the optical scanner 16a may differ according to the POS terminal. For example, in a self-checkout lane the customer may use an optical barcode scanner which is integrated into the POS terminal to capture the machine readable code 76. At a conventional checkout lane with a sales associate operating a POS terminal, the sales associate may use a handheld scanner 16a to capture the machine readable codes 76 from the mobile electronic device.

In some cases, the customer may have selected a greater number of products than can be carried within a single machine readable code 76. In this situation, the software can create a sequence of multiple different machine readable codes 76. These machine readable codes 76 may be displayed sequentially on the mobile electronic device 68 and captured by the scanner 16a. Where multiple machine readable codes 76 are prepared by the mobile self-checkout software, the first code 76 may identify itself as the first and the sequence may be quickly flashed (cycled) to the scanner as the scanner reads the multiple codes 76. If desired, each machine readable code 76 in the sequence can identify itself (1/4), (2/4), etc.

Alternatively, the first machine readable code 76 may indicate that it is number (1/4) and may provide a checksum for the whole payload. These pieces of data in the machine readable codes allow the POS terminal to determine if it received the entire series of machine readable codes 76. Some 2D barcodes have redundancy for error correction. If desired, the self-checkout software may lower the amount of redundancy checks to increase the payload data in the code.

While scanning the machine readable codes, the scanner 16a or POS terminal 10 can indicate, such as with a beep, after receiving the machine readable codes 76. The scanner 16a or POS terminal 10 may indicate if the receipt is successful or not successful, such as with a beep. The scanner 16a or POS terminal 10 may timeout if data is not received. The scanner 16a can operate for a fixed time period to acquire the machine readable codes.

In this manner, the information regarding the customer's selected products, such as UPC codes and quantity, may be provided from the mobile electronic device 68 to the POS terminal 10. This transfer of electronic shopping cart information is robust and may be completed without the use of any network connection or data connection between these devices. This may facilitate a successful transfer of the desired data and promote customer satisfaction.

The electronic shopping cart information may be transferred to the POS terminal in different ways. By way of example, a customer may approach the POS terminal 10 and use their mobile electronic device 68 to enter a code or capture a machine readable code at the POS terminal. The code may identify the POS terminal 10 to the server 34 and the customer may press a button on the mobile electronic device 68 to transmit the code to the server and pair the mobile electronic device 68 with that POS terminal. This pairing may cause the server 34 to transmit the electronic shopping cart information to the POS terminal 10.

After transmitting the electronic shopping cart information to the POS terminal 10, the customer may proceed with the checkout and payment process. A customer with self-checkout software on a mobile electronic device may have typically elected to receive electronic receipts on the mobile electronic device. The POS terminal 10 and server 34 may then transmit an electronic receipt to the mobile electronic device for the purchase. As multiple customers have contributed items to a shared electronic shopping cart, the server 34 may transmit electronic receipts to each customer associated with the shared electronic shopping cart. The customer who paid for the purchase may receive a fully functional electronic receipt which may be used for returns and other such related transactions. Other customers associated with the electronic shopping cart who did not pay for the transaction may be provided with electronic receipts which may not be used for returns, and the electronic receipt may be marked to indicate that it is not usable for returns.

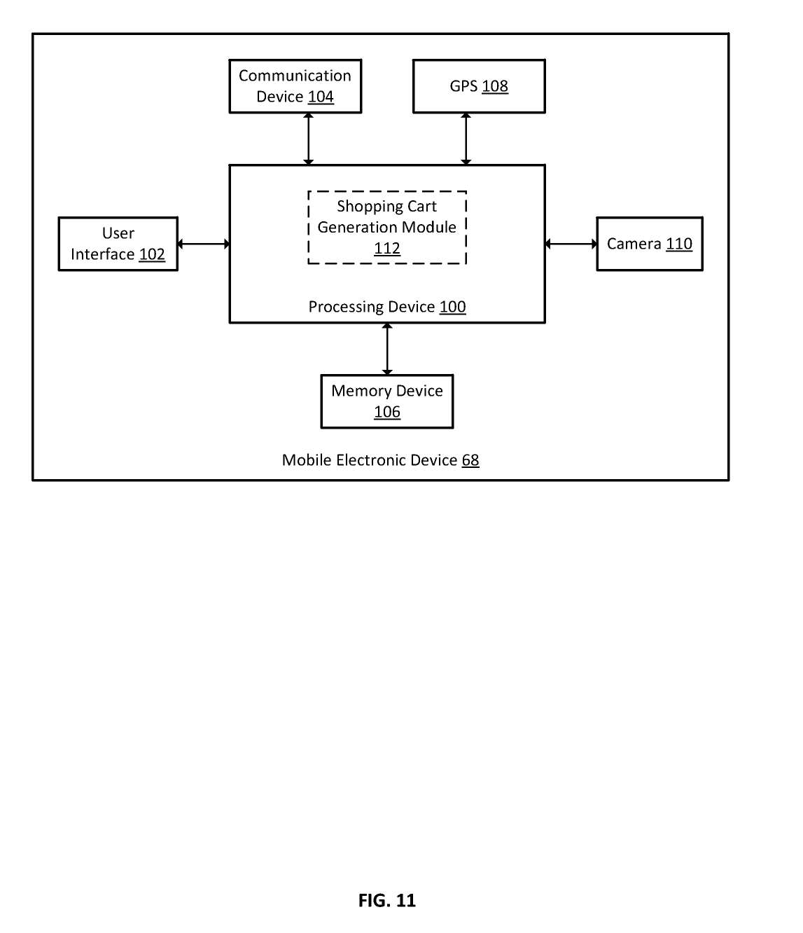

Referring now to FIG. 11, a schematic illustrating example components of the mobile electronic device 68 of FIG. 1 is illustrated. In the illustrative embodiment, the mobile electronic device includes a processing device 100, a user interface 102, a communication device 104, a memory device 106, a global positioning system (GPS) 108, and a camera 110. It is noted that the mobile electronic device 68 can include other components and some of the components are not required.

The processing device 100 can include memory, e.g., read only memory (ROM) and random access memory (RAM), storing processor-executable instructions and one or more processors that execute the processor-executable instructions. In embodiments where the processing device 100 includes two or more processors, the processors can operate in a parallel or distributed manner. The processing device 100 can execute the operating system of the mobile electronic device 68. In the illustrative example, the processing device 100 also executes an electronic shopping cart generation module 112 which is described in greater detail below.

The user interface 102 is a device that allows a user to interact with the mobile electronic device 68. While one user interface 102 is shown, the term “user interface” can include, but is not limited to, a touch screen, a physical keyboard, a mouse, a microphone, and/or a speaker. The communication device 104 is a device that allows the mobile electronic device 68 to communicate with another device, e.g., the server 34 or another mobile electronic device. The communication device 104 can include one or more wireless transceivers for performing wireless communication and/or one or more communication ports for performing wired communication. The memory device 106 is a device that stores data generated or received by the mobile electronic device 68. The memory device 106 can include, but is not limited to, a hard disc drive, an optical disc drive, and/or a flash memory drive.

The GPS 108 determines a location of the mobile electronic device 10 by communicating with a plurality of GPS satellites. The GPS 108 can perform known triangulation techniques to determine the GPS coordinates of the mobile electronic device 68. It should be appreciated that while a GPS 108 is shown, any other suitable component for determining the location of the mobile electronic device 68 can be implemented.

The camera 110 is a digital camera that captures a digital photograph. The camera 110 receives an instruction to capture an image such as a UPC code 72 from an item selected by a customer, captures an image of the object, and outputs the captured image. The camera 110 can receive the instruction to capture the image from the processing device 100 and can output the digital photograph to the processing device 100.

The electronic shopping cart generation module 112 allows a user to generate an electronic shopping cart and displays the electronic shopping cart to the user via the user interface 102. As discussed previously the shopping cart generation module 112 may be configured to generate the electronic shopping cart based on items scanned by a customer while shopping. The electronic shopping cart module 112 may receive images from the camera 110 and may utilize the communication device 104 to communicate changes to the electronic shopping cart with other paired customers who are contributing items to the same electronic shopping cart.

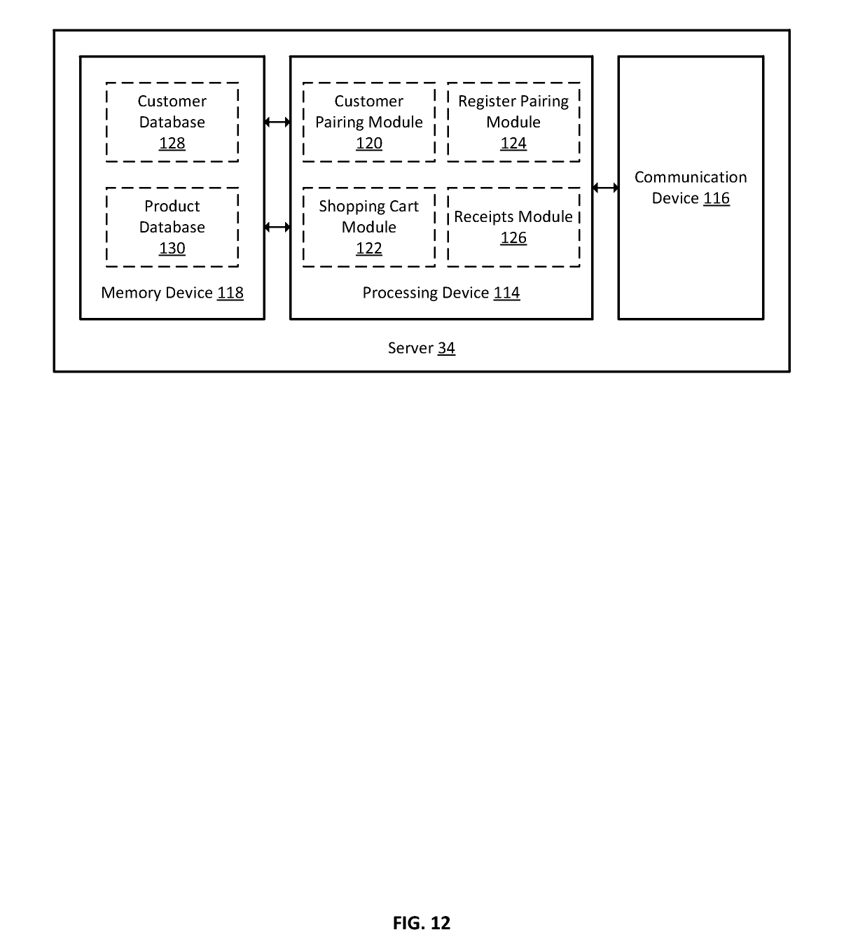

As referenced above, the server 34 may be configured to perform one or more functions at the request of the mobile electronic device 68. FIG. 12 illustrates an example embodiment of the server 34 configured to perform one or more of the requested functions. In the illustrated embodiment, the server 34 may include a processing device 114, a communication device 116, and a memory device 118.

The processing device 114 can include memory, e.g., read only memory (ROM) and random access memory (RAM), storing processor-executable instructions and one or more processors that execute the processor-executable instructions. In embodiments where the processing device 114 includes two or more processors, the processors can operate in a parallel or distributed manner. In the illustrative embodiment, the processing device 114 executes one or more of a customer pairing module 120, a shopping cart module 122, a register pairing module 124, and a receipts module 126.

The communication device 116 is a device that allows the server 34 to communicate with another device, e.g., the mobile electronic device 34. The communication device 116 can include one or more wireless transceivers for performing wireless communication and/or one or more communication ports for performing wired communication.

The memory device 118 is a device that stores data generated or received by the server 34. The memory device 118 can include, but is not limited to a hard disc drive, an optical disc drive, and/or a flash memory drive. Further, the memory device 118 may be distributed and located at multiple locations. The memory device 118 is accessible to the processing device 114. In some embodiments, the memory device 118 stores a customer database 128 and a product database 130.

In some embodiments, the customer database 128 can store information associated with a customer. The customer database may, for example, store information associated with a customer account and may include account preferences and customer contact information associated with a particular customer. The customer database may be queried by the processing device 114 and may provide information to the processing device to facilitate pairing customers together and to facilitate communications with the customers.

In some embodiments, the product database 130 stores product information for products sold by a retailer in the brick and mortar store. For example, the product database 130 may store information such as the name, brand, description, image, or price associated with products in the store. By way of example, the product database 130 may be queried by the processing device 114 and may transmit information to the processing device to facilitate the creation of an electronic shopping cart.

The processing device 114 may execute the customer pairing module 120. The customer pairing module may provide information such as a code to customers to allow the customers to pair mobile electronic devices 68 together. The customer pairing module may also receive information from the customers such as customer identification or codes to allow these customers to pair mobile electronic devices 68 together.

The shopping cart module 122 may receive item information from customers and may create an electronic shopping cart from this information as discussed herein. The shopping cart module 122 may receive item information from multiple customers and may provide updated electronic shopping cart information to multiple paired customers. The shopping cart module may receive additional information from the product database 130 and may provide this information to a customer as part of or in association with the electronic shopping cart information.

The register pairing module 124 may facilitate pairing between a mobile electronic device 68 and a POS terminal 10. The register pairing module 124 may receive information from the customer, such as receiving a code from a mobile electronic device 68 identifying a POS terminal 10. The register pairing module 124 may transmit information, such as by transmitting electronic shopping cart information to the POS terminal 10 to facilitate checkout. The receipts module 126 may provide electronic receipts to one or more customers following a completed purchase at the store. The receipts module 126 may receive information from the POS terminal 10, such as receiving information regarding the completed purchase which may include the items actually purchased, the payment method, etc. The receipts module 126 may provide receipt information, such as by providing electronic receipts to one or more customers following a completed purchase.

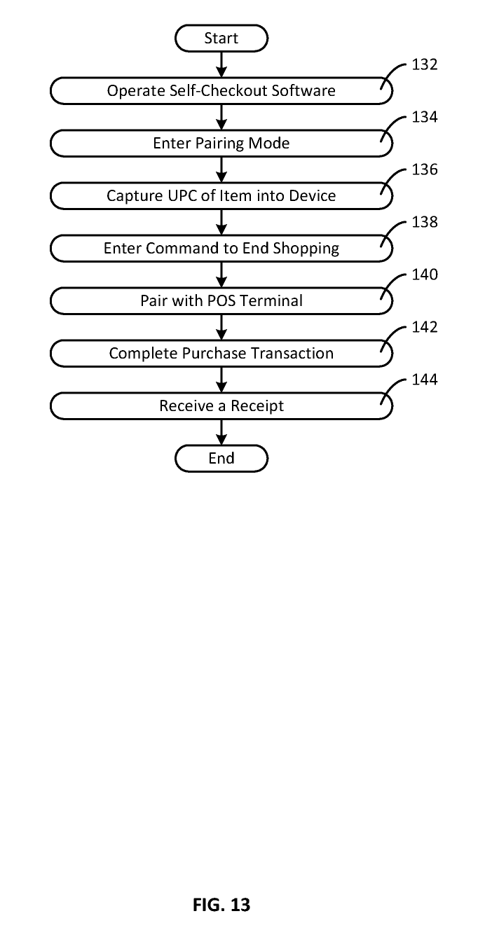

FIG. 13 generally illustrates creating an electronic shopping cart on mobile electronic devices 68 while customers are shopping in a brick and mortar store. A customer may first operate mobile self-checkout software 132 on a mobile electronic device 68. In operating self-checkout software, the customer may enter a shared shopping mode. The customer may then enter a pairing mode 134 wherein the customer pairs their mobile electronic device 68 with the mobile electronic device of one or more other customers. Pairing with other customers may involve transmitting a code or other information between mobile electronic devices and may involve communication with a server 34.

After multiple customers have paired mobile electronic devices 68 together, the customers may proceed to select items for purchase and capture codes 136 such as UPC codes on those items into their mobile electronic devices. If desired, the customer may enter price and quantity information for the product into the mobile electronic device using the self-checkout software. The product information may then be added to an electronic shopping cart having information regarding items selected for purchase. If a customer has already selected and scanned items for purchase before pairing, those items may be transferred to the other customer(s) as part of the shared electronic shopping list.

When the customers are finished selecting items for purchase, one of the customers may press a button or otherwise enter a command into their mobile electronic device to end shopping 138. Ending shopping may initiate a message to other paired customers that the electronic shopping cart is being closed or finalized for purchase and may provide an opportunity for these other customers to indicate whether or not they are finished shopping. Upon a received or confirmed instruction to end shopping, the electronic shopping cart may be prepared for transfer to a POS terminal for purchase. As has been discussed, the self-checkout software may prepare one or more machine readable codes with the electronic shopping cart information embedded therein. The electronic shopping cart information may also be prepared for transmittal to the POS terminal via the server 34.

When ready, the customer may pair 140 with a POS terminal for checkout. The customer will typically approach a POS terminal 10 with the items that the customer will purchase and with the electronic shopping cart information stored on a mobile electronic device 68. Pairing with a POS terminal 10 may include transmitting data between the POS terminal and the mobile electronic device such as the device 68 capturing a machine readable code at the POS terminal which identifies the particular POS terminal. Pairing the mobile electronic device 68 with a POS terminal 10 may also include transmitting data between the mobile electronic device and a server 34, such as transmitting information received from the POS terminal 10 to the server 34 to indicate with which particular POS terminal the customer is pairing the mobile electronic device. Upon pairing, the server 34 may transmit electronic shopping cart information to the POS terminal 10.

After the mobile electronic device 68 has been paired with the POS terminal 10 and the electronic shopping cart information has been transmitted to the POS terminal, any necessary adjustments may be made to the list of items for purchase. Any additional items which a customer desires to purchase but has not already added to the electronic shopping cart may be scanned at the POS terminal. Any items which the customer does not desire to purchase may be removed from the list of items on the POS terminal as necessary. The customer may then typically complete the purchase transaction 142 and receive a receipt 144. If desired, the customer who paid for the transaction may receive a fully functional receipt and other customers who contributed to the electronic shopping cart but did not pay for the transaction may receive a receipt which is not valid for returns. If desired, these customers may receive an electronic receipt.

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention. Indeed, it is appreciated that the specific example voltages, currents, frequencies, power range values, times, etc., are provided for explanation purposes and that other values may also be employed in other embodiments and examples in accordance with the teachings of the present invention.

What is claimed is:

1. A computer implemented method comprising:
electronically pairing a first mobile electronic device with a second mobile electronic device;
receiving a UPC code from a first physical item at a brick and mortar store into self-checkout software on the first mobile electronic device;
receiving first item information for the first physical item into the self-checkout software on the first mobile electronic device;
creating an electronic shopping cart with the first item information on the first mobile electronic device; and
transmitting information regarding the first physical item to the second mobile electronic device to thereby create a synced copy of the electronic shopping cart on the second mobile electronic device.

2. The method of claim 1, wherein the method further comprises:
receiving a UPC code from a second physical item at the brick and mortar store into self-checkout software on the second mobile electronic device;
receiving second item information for the second physical item into the self-checkout software on the second mobile electronic device;
including the second item information in the electronic shopping cart on the second mobile electronic device; and
transmitting information to the first mobile electronic device to include the second item information in the electronic shopping cart on the first mobile electronic device.

3. The method of claim 2, wherein the method comprises maintaining a synced copy of the electronic shopping cart on the first mobile electronic device and the second mobile electronic device.

4. The method of claim 2, wherein the method further comprises indicating, for an item in the electronic shopping cart, a mobile electronic device which added said item to the electronic shopping cart.

5. The method of claim 2, wherein the method further comprises associating each item in the electronic shopping cart with a mobile electronic device which added said item to the electronic shopping cart.

6. The method of claim 5, wherein the method further comprises creating a unique item identification for each item in the electronic shopping cart, and wherein the unique item identification associates said item with a mobile electronic device which added said item to the electronic shopping cart.

7. The method of claim 6, wherein the method further comprises receiving an instruction to remove an item from the electronic shopping cart on a mobile electronic device, said item having been added to the electronic shopping cart by said mobile electronic device, identifying said item in the electronic shopping cart by a unique item identification associating said item with said mobile electronic device, and removing said item from the electronic shopping cart.

8. The method of claim 5, wherein the method further comprises visually dividing the electronic shopping cart to visually display items added by a mobile electronic device in a group.

9. The method of claim 1, wherein the method further comprises receiving an instruction to finish shopping from either of the first mobile electronic device and second mobile electronic device and closing the electronic shopping cart for checkout in response thereto.

10. The method of claim 1, wherein the method further comprises permitting either of the first mobile electronic device or the second mobile electronic device to transmit electronic shopping cart information to a POS terminal to complete a purchase transaction.

11. The method of claim 1, wherein the step of electronically pairing a first mobile electronic device with a second mobile electronic device comprises associating the first mobile electronic device with the second mobile electronic device on a store server.

12. The method of claim 11, wherein the method further comprises the first mobile electronic device transmitting information regarding the first physical item to the server and the server transmitting information regarding the first physical item to the second mobile electronic device.

13. The method of claim 1, wherein the step of electronically pairing a first mobile electronic device with a second mobile electronic device comprises providing information to the first mobile electronic device, receiving the information into the second mobile electronic device, and the server receiving the information from the second mobile electronic device to associate the first mobile electronic device with the second mobile electronic device.

14. A computer system comprising:
a shopping cart module programmed to:
receive a UPC code from a first physical item at a brick and mortar store via a first mobile electronic device;
receive first item information for the first physical item into the first mobile electronic device; and
create an electronic shopping cart with the first item information on the first mobile electronic device; and
a communication device programmed to:
transmit information regarding the first physical item to a second mobile electronic device to thereby create a synced copy of the electronic shopping cart on the second mobile electronic device.

15. The system of claim 14, wherein:
the shopping cart module is programmed to:
receive a UPC code from a second physical item at the brick and mortar store via the second mobile electronic device;
receive second item information for the second physical item into the second mobile electronic device;
include the second item information in the electronic shopping cart on the second mobile electronic device; and
the communication device is programmed to:
transmit information to the first mobile electronic device to include the second item information in the electronic shopping cart on the first mobile electronic device.

16. The system of claim 15, wherein:
the shopping cart module is programmed to:
associate each item in the electronic shopping cart with a mobile electronic device which added said item to the electronic shopping cart; and
further comprising a user interface programmed to:
display on the first mobile electronic device and the second mobile electronic device an identification of the mobile electronic device which added each item to the electronic shopping cart.

17. The system of claim 16, wherein the shopping cart module is programmed to:
create a unique item identification for each item in the electronic shopping cart, and wherein the unique item identification associates said item with a mobile electronic device which added said item to the electronic shopping cart.

18. The system of claim 17, wherein the shopping cart module is programmed to:
receive an instruction to remove an item from the electronic shopping cart via a mobile electronic device, said item having been added to the electronic shopping cart by said mobile electronic device, identify said item in the electronic shopping cart by a unique item identification associating said item with said mobile electronic device, and remove said item from the electronic shopping cart.

19. The system of claim 16, wherein the user interface is programmed to divide the electronic shopping cart to visually display items added by a mobile electronic device in a group.

20. The system of claim 14, further comprising a customer pairing module programmed to:
electronically pair the first mobile electronic device with the second mobile electronic device by receiving information from the first mobile electronic device and from the second mobile electronic device into a store server to associate the first electronic device with the second electronic device.
